(19) United States
(12) Patent Application Publication
(10) Pub. No.: US 2024/0405665 A1
(43) Pub. Date: Dec. 5, 2024

(54) SWITCHING POWER SUPPLY APPARATUS

(71) Applicant: ROHM CO., LTD., Kyoto-shi (JP)

(72) Inventor: Kazuhiro HORII, Kyoto-shi (JP)

(21) Appl. No.: 18/801,943

(22) Filed: Aug. 13, 2024

Related U.S. Application Data
(63) Continuation of application No. PCT/JP2023/003395, filed on Feb. 2, 2023.

(30) Foreign Application Priority Data
Feb. 18, 2022 (JP) 2022-024105

(51) Int. Cl. H02M 1/32; H02M 1/00; H02M 3/335

(52) U.S. Cl. CPC H02M 1/32; H02M 1/0009; H02M 3/33507

(57) ABSTRACT

In a calibration step, a search processing unit changes a setting value so as to search for a critical value that corresponds to a boundary that defines whether or not overcurrent protection functions in a state in which a switching power supply apparatus is operated with a current at which overcurrent protection is to function in normal operation of the switching power supply apparatus. In a calibration step, a digital processor writes the setting value based on the critical value searched for by the search processing unit to nonvolatile memory. In the normal startup operation of the switching power supply apparatus, the digital processor reads the setting value from the nonvolatile memory and sets the setting value for the overcurrent detection circuit.

### CROSS REFERENCE TO RELATED APPLICATIONS

This application is a continuation under 35 U.S.C. § 120 of PCT/JP2023/003395, filed Feb. 2, 2023, which is incorporated herein by reference, and which claimed priority to Japanese Application No. 2022-024105, filed Feb. 18, 2022. The present application likewise claims priority under 35 U.S.C. § 119 to Japanese Application No. 2022-024105, filed Feb. 18, 2022, the entire content of which is also incorporated herein by reference.

### BACKGROUND

### 1. Technical Field

The present disclosure relates to a switching power supply apparatus.

### 2. Related Art

Electronic devices, industrial equipment, industrial machinery, and automobiles are each provided with a power supply circuit that converts a voltage from a main power supply into a power supply voltage that is suitable for a circuit. In order to protect a switching power supply apparatus from an overload state, an overcurrent protection function is implemented.

The overcurrent protection function is a function of monitoring a current having a correlation with an output current (load current), and of limiting or reducing the duty cycle of a switching element of the switching power supply apparatus, or of changing the switching frequency, so as to reduce electric power to be supplied to a load or to stop the switching operation, when the monitored current exceeds a threshold value.

In order to detect a current having such a correlation with the output current, a sense resistor is provided on a path of the current. A voltage drop occurs across the sense resistor in proportion to the current. By comparing the voltage drop with a threshold value, the overcurrent state can be detected.

In a case in which the sense resistor has a large resistance value, this leads to a large loss. Accordingly, the sense resistor is required to have as small a resistance value as possible. Conversely, in a case in which the sense resistor has a small resistance value, this leads to a small voltage drop when the same amount of current flows. This leads to degraded precision of current detection.

The switching supply apparatus is designed to prevent degraded reliability of the apparatus even in the overcurrent state. In a case in which there is variation in the overcurrent protection, it is necessary to select a power semiconductor element (switching element), choke coil, or transformer giving consideration to such variation. Furthermore, it is necessary to design a large-scale cooling mechanism.

With a switching power supply apparatus with a given output current I_{MAX} as its maximum current, in a case in which there is no variation in the overcurrent protection, an operating threshold value of (1.1×I_{MAX}) can be employed for the overcurrent protection assuming a margin of 10%. However, for example, in a case in which the operating threshold value of the overcurrent protection has an error of +30%, in order to prevent the occurrence of a malfunction of the protection operation even in a case in which the operating threshold value for the overcurrent protection becomes-30%, the operating threshold value for the overcurrent protection must be designed to be (1.4×I_{MAX}). In this case, in order to ensure the reliability of the switching power supply apparatus even if variation occurs in the actual operating threshold value for the overcurrent protection toward the large-value side by +30%, the switching power supply apparatus must be designed with (1.7×I_{MAX}) as its maximum allowable current.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram of a circuit system provided with a switching power supply apparatus according to an embodiment,

FIG. 2 is a diagram showing a setup in a calibration step for the switching power supply apparatus shown in FIG. 1,

FIG. 3 is a diagram for explaining the operation of the switching power supply apparatus in the calibration step,

FIG. 4 is a circuit diagram of a switching power supply apparatus according to Embodiment 1,

FIG. 5 is a waveform diagram showing a first example of operation of the switching power supply apparatus shown in FIG. 4 in the calibration step,

FIG. 6 is a waveform diagram showing a second example of operation of the switching power supply apparatus shown in FIG. 4 in the calibration step,

FIG. 7 is a circuit diagram of a switching power supply apparatus according to Embodiment 2,

FIG. 8 is a waveform diagram showing a first example of operation of the switching power supply apparatus shown in FIG. 7 in the calibration step,

FIG. 9 is a waveform diagram showing a second example of operation of the switching power supply apparatus shown in FIG. 7 in the calibration step,

FIG. 10 is a circuit diagram of a switching power supply apparatus according to Embodiment 3; and

FIG. 11 is a waveform diagram showing an example of operation of the switching power supply apparatus shown in FIG. 10 in the calibration step.

### DETAILED DESCRIPTION

### Outline of Embodiments

Description will be made regarding the outline of several exemplary embodiments of the present disclosure. The outline is a simplified explanation regarding several concepts of one or multiple embodiments as a preface to the detailed description described later in order to provide a basic understanding of the embodiments. That is to say, the outline described below is by no means a comprehensive outline of all the possible embodiments. That is to say, the outline is by no means intended to identify the indispensable or essential elements of all the embodiments and is by no means intended to define the scope of a part of or all the embodiments. For convenience, in some cases, an “embodiment” as used in the present specification represents a single or multiple embodiments (examples and modifications) disclosed in the present specification.

A switching power supply apparatus according to one embodiment includes: at least one switching element; a control circuit structured to drive the switching element; an overcurrent detection circuit structured to assert an overcurrent detection signal when a current that flows through a predetermined path of the switching power supply apparatus exceeds a threshold current, and to be capable of adjusting the threshold current according to a setting value; nonvolatile memory structured to hold a setting value to be supplied to the overcurrent detection circuit in normal operation of the switching power supply apparatus; a search processing unit structured to change the setting value in the calibration step so as to search for a critical value to be employed as the setting value that corresponds to a boundary that defines whether or not the overcurrent protection functions when the switching power supply apparatus operates with a current value at which the overcurrent protection is to function in normal operation thereof; and a digital processor structured to write the critical value obtained by the search by the search processing unit to the nonvolatile memory in the calibration step, and to read the critical value from the nonvolatile memory so as to set the critical value in the overcurrent detection circuit in a normal startup operation of the switching power supply apparatus.

With this arrangement in which, in the calibration step, judgment is made regarding whether or not overcurrent protection has functioned for each setting value while changing the setting value for the overcurrent detection circuit, so as to search for a critical value thereof, this is capable of setting an optimum threshold current for each switching power supply apparatus.

In one embodiment, in the calibration step, a constant current load structured to generate a predetermined constant current may be coupled to an output terminal of the switching power supply apparatus. This allows the threshold current of the overcurrent detection circuit to be optimized such that the constant current generated by the constant current load is the maximum load current.

In one embodiment, the switching power supply apparatus may be configured as a switching converter including a transformer. Also, the switching element may be coupled to a primary winding of the transformer.

In one embodiment, the predetermined path may be structured as a path arranged in series with a primary winding of the transformer.

In one embodiment, the search processing unit may monitor whether or not the overcurrent detection signal is asserted or negated while changing the setting value.

In one embodiment, the search processing unit may monitor the voltage level of an output voltage of the switching power supply apparatus while changing the setting value.

In one embodiment, the search processing unit may continuously sweep the setting value.

In one embodiment, the search processing unit may continuously sweep the setting value from a larger value toward a smaller value.

In one embodiment, the search processing unit may continuously sweep the setting value from a smaller value toward a larger value.

In one embodiment, the switching power supply apparatus may be structured to latch stop in response to an assertion of the overcurrent detection signal.

In one embodiment, the switching power supply apparatus may further include a latch stop circuit structured to generate a latch stop signal in response to an assertion of the overcurrent detection signal. Also, the search processing unit may monitor the latch stop signal.

In one embodiment, the function of the search processing unit may be provided as a software process implemented in the same hardware component as the digital processor.

In one embodiment, the function of the overcurrent detection circuit may be provided as a hardware operation external to the digital processor.

In one embodiment, the function of the search processing unit may be provided as a hardware operation, or a software process implemented in the same hardware component as the digital processor.

A digital processor according to one embodiment is employed in a switching power supply apparatus. The switching power supply apparatus includes: at least one switching element; a control circuit structured to drive the switching element; and an overcurrent detection circuit structured to assert an overcurrent detection signal when a current that flows through a predetermined path of the switching power supply apparatus exceeds a threshold current, and to be capable of adjusting the threshold current according to a setting value. The digital processor includes: nonvolatile memory structured to hold the setting value to be supplied to the overcurrent detection circuit in the normal operation of the switching power supply apparatus; and a processing unit structured to be capable of receiving an adjustment start signal, to enter a calibration mode with the adjustment start signal as a trigger, to change the setting value in a state in which the switching power supply apparatus is operated with a current at which overcurrent protection is to function in normal operation of the switching power supply apparatus, so as to search for a critical value that corresponds to a boundary that defines whether or not the overcurrent protection functions, to write the critical value obtained as a result of the search to the nonvolatile memory, and to read the critical value from the nonvolatile memory so as to set the critical value in the overcurrent detection circuit in a normal startup operation of the switching power supply apparatus.

### EMBODIMENTS

Description will be made below regarding preferred embodiments with reference to the drawings. The same or similar components, members, and processes are denoted by the same reference numerals, and redundant description thereof will be omitted as appropriate. The embodiments have been described for exemplary purposes only and are by no means intended to restrict the present disclosure and the present invention. Also, it is not necessarily essential for the present disclosure and the present invention that all the features or a combination thereof be provided as described in the embodiments.

In the present specification, a state represented by the phrase “the member A is coupled to the member B” includes a state in which the member A is indirectly coupled to the member B via another member that does not substantially affect the electric connection between them, or that does not damage the functions or effects of the connection between them, in addition to a state in which they are physically and directly coupled.

Similarly, a state represented by the phrase “the member C is provided between the member A and the member B” includes a state in which the member A is indirectly coupled to the member C, or the member B is indirectly coupled to the member C via another member that does not substantially affect the electric connection between them, or that does not damage the functions or effects of the connection between them, in addition to a state in which they are directly coupled.

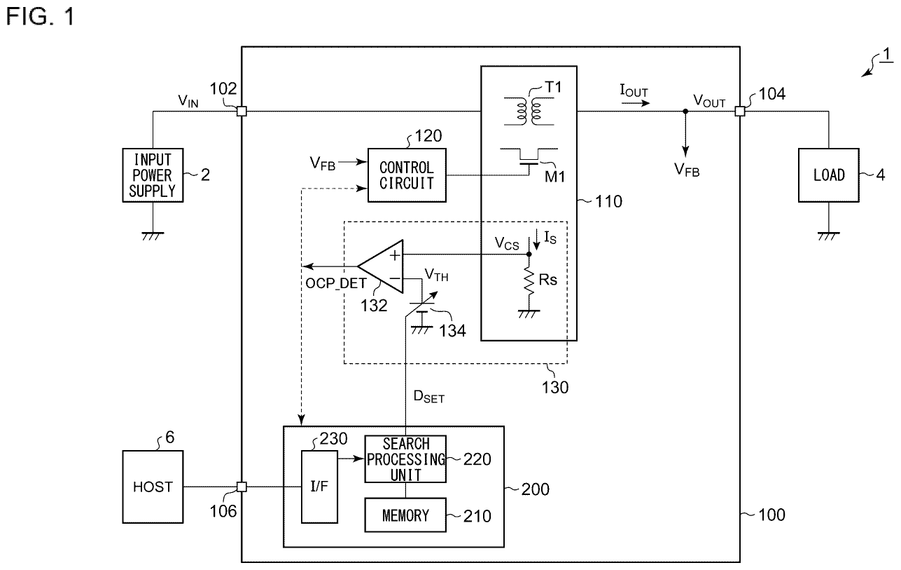

FIG. 1 is a block diagram of a circuit system 1 provided with a switching power supply apparatus 100 according to an embodiment. The circuit system 1 is shown in a product state. The circuit system 1 includes an input power supply 2, a load 4, a host controller 6, and a switching power supply apparatus 100.

The switching power supply apparatus 100 receives an input voltage VIN via an input line (input terminal) 102 from the input power supply 2. The load 4 is coupled to an output line (output terminal) 104 of the switching power supply apparatus 100. The switching power supply apparatus 100 converts the input voltage VIN into an output voltage V_{OUT} having a predetermined voltage level and supplies the output voltage V_{OUT} to the load 4.

The switching power supply apparatus 100 includes a main circuit 110, a control circuit 120, an overcurrent detection circuit 130, a digital processor 200, nonvolatile memory 210, and a search processing unit (or search processing function) 220. It should be noted that each block shown in FIG. 1 represents processing implemented in the switching power supply apparatus 100. That is to say, each block does not necessarily represent a hardware unit or a hardware configuration.

The main circuit 110 is a main part of the switching power supply. The main circuit 110 includes at least one switching element M1, a transformer T1, a rectifier circuit (not shown), and a smoothing capacitor. The configuration and topology of the main circuit 110 are not restricted in particular. Also, the main circuit 110 may be configured as an isolated or otherwise non-isolated circuit. Examples of the main circuit 110 include a forward converter, flyback converter, half-bridge converter, full-bridge converter, etc. Also, the main circuit 110 may have a topology including an inductor (reactor) instead of a transformer. For example, the main circuit 110 may be configured as a step-down (Buck) converter, step-up (Boost) converter, step-up/step-down (Buck-Boost) converter, Cuk converter, or SEPIC converter.

The control circuit 120 drives the switching element M1 such that the output voltage V_{OUT} of the output line 104 becomes a predetermined voltage V_{OUT(REF)}. For example, the control circuit 120 receives the input of a feedback signal V_{FB} that corresponds to the output voltage V_{OUT}. The duty cycle or the switching frequency of the switching of the switching element M1 is feedback-controlled according to the feedback signal V_{FB}. Also, the present invention is applicable to a switching power supply apparatus operating without feedback control, e.g., a switching power supply apparatus that controls the switching element M1 with a fixed duty cycle.

The control circuit 120 may be configured using a known technique. That is to say, the configuration and the control method are not restricted in particular. Known examples of the control method for the control circuit 120 include a Pulse Width Modulation (PWM) method, Pulse Frequency Modulation (PFM) method, phase shift method, etc. A control method suitable for the topology of the main circuit 110 may preferably be employed.

When a current Iₛ that flows through a predetermined path of the switching power supply apparatus 100 exceeds a threshold current I_{OCP}, the overcurrent detection circuit 130 asserts an overcurrent detection signal OCP_DET. The overcurrent detection circuit 130 is capable of adjusting the threshold current I_{OCP} according to a setting value D_{SET}.

For example, the overcurrent detection circuit 130 includes a sense resistor Rs, an overcurrent detection comparator 132, and a digitally controlled variable voltage source 134.

The digitally controlled variable voltage source 134 receives the digital setting value D_{SET} output from the digital processor 200 and generates a threshold voltage V_{TH} that corresponds to the setting value D_{SET}. The digitally controlled variable voltage source 134 may include a D/A converter configured to convert the digital setting value D_{SET} into an analog voltage V_{TH}.

The sense resistor Rs is arranged on a path of a current Iₛ having a correlation with the output current I_{OUT} in the main circuit 110. Here, “K” represents a coefficient based on the topology of the main circuit 110 and the layout of the path through which the current Iₛ flows.

$${I}_{S} = K \times {I}_{OUT}$$

A voltage drop (current detection signal) V_{CS} that is proportional to the current Iₛ occurs in the sense resistor Rs.

$${V}_{C S} = {I}_{S} \times R s .$$

The overcurrent detection comparator 132 compares the current detection signal V_{CS} with the threshold voltage V_{TH}. When V_{CS}<V_{TH}, the OCP_DET signal is negated (e.g., low level), and when V_{CS}>V_{TH}, the OCP_DET signal is asserted (e.g., high level). That is to say, when K·I_{OUT}×Rs>V_{TH}, the OCP_DET signal is asserted. That is to say, the threshold current I_{OUT(OCP)} with respect to the output current I_{OUT} of the overcurrent detection circuit 130 is represented by the following Expression.

$${I}_{OUT ( OCP )} = {V}_{TH} / ( Rs \times K ) \qquad ( 1 )$$

The OCP_DET signal is input to the control circuit 120 or the digital processor 200. The control circuit 120 or the digital processor 200 executes predetermined overcurrent protection in response to an assertion of the OCP_DET signal. For example, the control circuit 120 may execute pulse-by-pulse overcurrent protection in response to an assertion of the OCP_DET signal. Specifically, the switching element M1 may be turned off every time the OCP_DET signal is asserted. Also, the control circuit 120 or the digital processor 200 may be latch stopped in response to an assertion of the OCP_DET signal.

The switching power supply apparatus 100 includes the digital processor 200 configured to integrally control the switching power supply apparatus 100. A software component is implemented in the digital processor 200 in order to control the switching power supply apparatus 100. Specifically, the switching power supply apparatus 100 is controlled by a combination of a processor and a software program to be executed by the processor.

The digital processor 200 is provided with a communication interface (communication circuit) 230. The communication interface 230 is capable of communicating with the external host controller 6 via a communication line 106. The digital processor 200 controls the switching power supply apparatus 100 based on data received from the host controller 6.

The function of the digital processor 200 is not restricted in particular. For example, the digital processor 200 controls the rotation speed of an unshown fan according to the temperature. As another example, the digital processor 200 monitors the input voltage VIN. When the input voltage VIN exceeds a predetermined voltage, the digital processor 200 sets the switching power supply apparatus 100 to an operation state. Conversely, when the input voltage VIN falls, the digital processor 200 stops the switching power supply apparatus 100. In a case in which the main circuit 110 is configured as a synchronous rectification circuit, the digital processor 200 may support dead time adjustment or the like.

The nonvolatile memory 210 stores a critical value D_{SET_OCP} obtained by the search processing unit 220 as a result of searching for the setting value D_{SET}. In a calibration step described later, the search processing unit 220 is activated. In this state, the search processing unit 220 searches for an optimum critical value D_{SET_OCP} for the switching power supply apparatus 100. The calibration step is executed after manufacturing and before shipping of the switching power supply apparatus 100.

The nonvolatile memory 210 may be built into the digital processor 200. Also, the nonvolatile memory 210 may be provided external to the digital processor 200. Also, the search processing unit 220 may be implemented as a function of the digital processor 200. Specifically, the search processing unit 220 may be provided as software processing implemented in the same hardware component as the digital processor 200, i.e., a combination of a processor and a software program to be executed by the processor. Also, the search processing unit 220 may be implemented as hardware processing implemented in the same hardware component as the digital processor 200. Specifically, the search processing unit 220 may be provided as hardware logic.

The digital processor 200 stores the critical value D_{SET_OCP}, which is obtained by the search processing unit 220 as a result of searching for the setting value D_{SET} to be supplied to the overcurrent detection circuit 130, in the nonvolatile memory 210. Furthermore, when the switching power supply apparatus 100 starts up normally, the digital processor 200 reads the critical value D_{SET_OCP} from the nonvolatile memory 210 and loads the critical value D_{SET_OCP} into the overcurrent detection circuit 130.

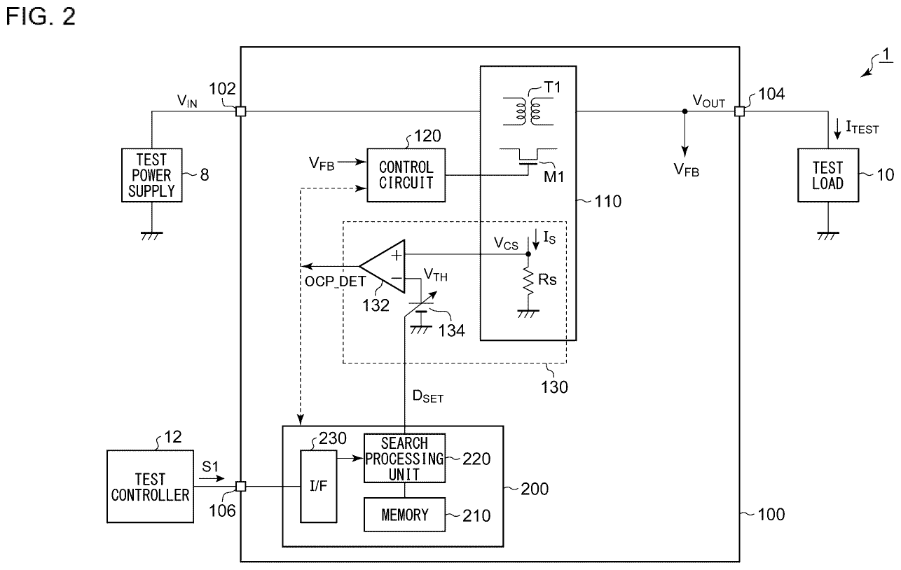

The above is the configuration of the switching power supply apparatus 100. Next, description will be made regarding the operation thereof. FIG. 2 is a diagram showing a setup in a calibration step of the switching power supply apparatus 100 shown in FIG. 1.

A test power supply 8 is coupled to the input line 102 of the switching power supply apparatus 100. The test power supply 8 generates the input voltage VIN.

In the calibration step, the switching power supply apparatus 100 is operated using a current value at which the overcurrent protection is to function in normal operation. In this case, the current value at which the overcurrent protection is to function is the output current I_{OUT} adjusted to be equal to a design value of the operating threshold current I_{OUT(OCP)} for the overcurrent protection. In order to output the output current Jour that is equal to the threshold current I_{OUT(OCP)} from the switching power supply apparatus 100, a calibration test load 10 is coupled to the output line 104 of the switching power supply apparatus 100. The test load 10 is configured as a constant current load. The test load 10 generates a test current I_{TEST} having the same amount as that of the design value of the operating threshold current I_{OUT(OCP)} for the overcurrent protection.

In the calculation step, a test controller 12 is coupled to the communication interface 230 of the switching power supply apparatus 100 via the communication line 106. The test controller 12 may control the test power supply 8 or the test load 10.

The test controller 12 outputs an adjustment start signal S1 to the digital processor 200. When the communication interface 230 receives the adjustment start signal S1, the digital processor 200 activates the search processing unit 220. In the calibration step, the control circuit 120 drives the switching element M1 of the main circuit 110 such that the output voltage V_{OUT} becomes a predetermined voltage V_{OUT(REF)} in the same manner as in normal operation.

The search processing unit 220 changes the setting value D_{SET} with time, and judges whether or not the overcurrent protection has functioned every time the setting value D_{SET} is changed. Judgment of whether or not the overcurrent detection has functioned may be made based on monitoring of the OCP_DET signal or based on a different change of voltage or current induced by the overcurrent protection. With this, the search processing unit 220 searches for the critical value D_{SET_OCP} that corresponds to the boundary that defines whether or not the overcurrent protection functions with respect to the setting value D_{SET}.

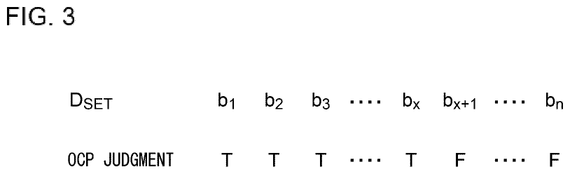

FIG. 3 is a diagram for explaining the operation of the switching power supply apparatus 100 in the calibration step. FIG. 3 shows multiple values b₁ to bₙ of the setting values D_{SET} and the results of whether or not the overcurrent protection has functioned. Here, it is assumed that b₁<bₙ holds true, and that the operation threshold value I_{OCP} of the overcurrent protection used in the overcurrent detection circuit 130 is higher toward the right side. In the OCP judgment, “T” represents a state in which the overcurrent protection has functioned, and “F” represents a state in which the overcurrent protection has not functioned.

In this example, the drawing shows that the overcurrent protection functions in a range of the setting value D_{SET} between b₁ and b_{X}, and that the overcurrent protection does not function in a range of the setting value D_{SET} between b_{X+1} and bₙ. That is to say, the value b_{X} (or b_{X+1}) is the critical value D_{SET_OCP} that corresponds to the boundary of whether or not the overcurrent protection functions.

The digital processor 200 stores the value b_{X} (or b_{X+1}) as the critical value D_{SET_OCP} in the nonvolatile memory 210. In the system 1 shown in FIG. 1, the overcurrent protection circuit operates using the critical value D_{SET_OCP} in normal operation.

The above is the calibration step of the switching power supply apparatus 100.

With the switching power supply apparatus 100 configured to judge whether or not the overcurrent protection has functioned every time the setting value D_{SET} of the overcurrent detection circuit 130 is changed so as to search for the critical value D_{SET_OCP} of the setting value D_{SET}, this is capable of setting an optimum threshold current I_{OCP} for each switching power supply apparatus.

Here, in the present embodiment, in the calibration step, the switching power supply apparatus 100 is operated in a state in which the output current I_{OUT} is equal to the design value of the operating threshold current I_{OUT(OCP)} for the overcurrent protection. Accordingly, the critical value D_{SET_OCP} is adjusted such that the operating threshold current I_{OUT(OCP)} for the overcurrent protection is equal to the design value.

The advantages of the present embodiment can be clearly understood in comparison with conventional techniques. In the comparison technique, the critical value D_{SET_OCP} is searched for such that it matches the critical point of functioning or non-functioning of the overcurrent protection in a state in which the current I_{S} is equal to the design value of the threshold value I_{OCP}. That is to say, in the comparison technique, the overcurrent I_{OCP} is calibrated with respect to the current I_{S}. In the comparison technique, in a case in which variation occurs in the parameter K in Expression (1), this leads to variation in the threshold value I_{OUT(OCP)} of the output current I_{OUT}.

With the embodiment, even in a case in which variation occurs in the parameter K, this allows the critical value D_{SET_OCP} to be adjusted such that the overcurrent threshold value I_{OUT(OCP)} matches the design value.

The present disclosure encompasses various kinds of apparatuses and methods that can be regarded as a block configuration or a circuit configuration shown in FIG. 1, or otherwise that can be derived from the aforementioned description. That is to say, the present disclosure is not restricted to a specific configuration. More specific description will be made below regarding example configurations or examples for clarification and ease of understanding of the essence of the present disclosure and the present invention and the operation thereof. That is to say, the following description will by no means be intended to restrict the technical scope of the present disclosure.

### Example 1

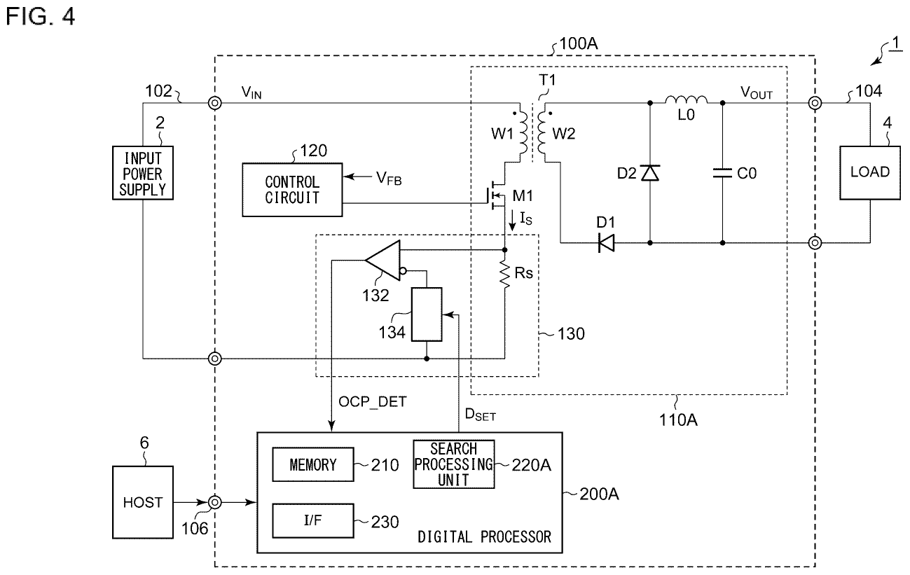

FIG. 4 is a circuit diagram of a switching power supply apparatus 100A according to Example 1. In the switching power supply apparatus 100A, a main circuit 110A is configured as a forward converter including a transformer T1, a switching element M1, rectifier elements D1 and D2, an output choke coil L0, and an output capacitor C0.

The control circuit 120 drives the switching element M1 based on the feedback signal V_{FB}. The method for generating the feedback signal V_{FB} is determined according to the usage of the switching power supply apparatus 100A. In a case of employing an isolated application, the switching power supply apparatus 100A includes a photocoupler and a shunt regulator on the secondary side of the transformer (which are both unshown). The shunt regulator drives a light-emitting element on the input side of the photocoupler using a current that corresponds to the difference between the output voltage V_{OUT} and its target voltage V_{OUT(REF)}. The control circuit 120 receives an input of the feedback signal V_{FB} that corresponds to a current that flows through the light-emitting element on the output side of the photocoupler. The control circuit 120 generates a pulse signal having a duty cycle that corresponds to the feedback signal V_{FB}, so as to drive the switching element M1.

Also, in a case of employing such an isolated application, an auxiliary winding may be provided as an additional component to the output choke coil L0. With such an arrangement, a voltage that occurs across the auxiliary winding may be fed back as the feedback signal V_{FB} to the control circuit 120. In this case, the control circuit 120 adjusts the duty cycle of the internal pulse signal by feedback such that the feedback signal V_{FB} approaches its target value, so as to drive the switching element M1.

In a case of employing a non-isolated application, the output voltage V_{OUT} may be directly input as the feedback signal V_{FB} to the control circuit 120 with or without voltage division.

It can be clearly understood by those skilled in this art that the control circuit 120 and an associated feedback system can be designed according to the usage of the switching power supply apparatus 100A. Also, in a case of employing a switching power supply apparatus configured to operate without feedback control, the switching element M1 may be driven with a fixed duty cycle without inputting the feedback signal V_{FB} to the control circuit 120.

The sense resistor Rs of an overcurrent detection circuit 130A is coupled in series to a primary winding W1 of the transformer T1 and the switching element M1. Accordingly, the primary current that flows through the primary winding W1 is employed as the current I_{S} to be monitored by the overcurrent detection circuit 130A.

In Example 1, the OCP_DET signal generated by the overcurrent detection circuit 130 is input to a digital processor 200A. In the search for the critical value, the search processing unit 220A judges based on the OCP_DET signal whether or not the overcurrent protection has functioned. Specifically, upon detecting the assertion of the OCP_DET signal, the search processing unit 220A judges that the overcurrent detection has functioned. Conversely, when the OCP_DET signal is negated, the search processing unit 220A judges that the overcurrent protection has not functioned.

The above is the configuration of the switching power supply apparatus 100A.

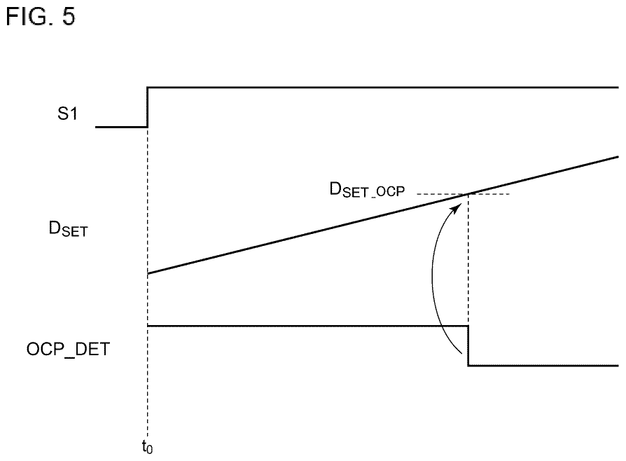

FIG. 5 is a waveform diagram showing a first example of operation in the calibration step of the switching power supply apparatus 100A shown in FIG. 4. When an adjustment start signal S1 is asserted at the time point to, the search processing unit 220A continuously sweeps the setting value D_{SET}. In the example shown in FIG. 5, the search processing unit 220A sweeps up the setting value D_{SET} from a low value to a high value. As the sweep start value, a value may preferably be selected from a range that is lower than the critical value D_{SET_OCP}.

In a range in which the setting value D_{SET} is lower than the critical value D_{SET_OCP}, the operation threshold value of the overcurrent protection is low. Accordingly, in this case, the OCP_DET signal is asserted, and judgment is made that the overcurrent protection is functioning. When the setting value D_{SET} exceeds a particular critical value, the OCP_DET signal is no longer asserted. In this state, judgment is made that the overcurrent protection has stopped functioning.

The value of the setting value D_{SET} when the OCP_DET signal is no longer asserted is written as the critical value D_{SET_OCP} to the nonvolatile memory 210.

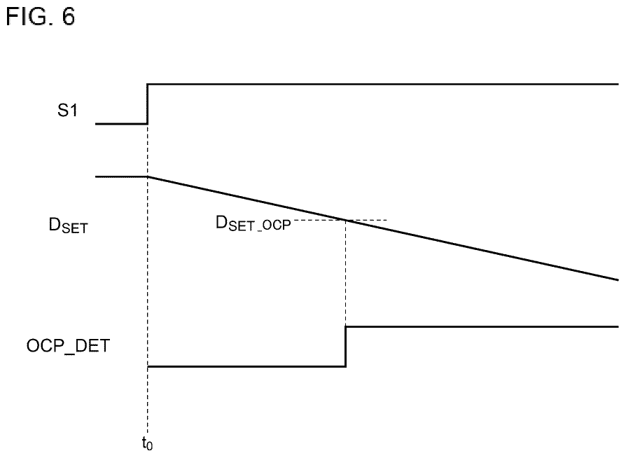

FIG. 6 is a waveform diagram showing a second example of operation in the calibration step of the switching power supply apparatus 100A shown in FIG. 4. In the second example of operation, the setting value D_{SET} is swept down from a high value to a low value.

In a range in which the setting value D_{SET} is higher than the critical value D_{SET_OCP}, the operation threshold value of the overcurrent protection is high. In this state, the OCP_DET signal is not asserted. Accordingly, judgment is made that the overcurrent protection has not functioned. After the setting value D_{SET} becomes lower than the critical value D_{SET_OCP}, the OCP_DET signal is asserted. In this state, judgment is made that the overcurrent protection has functioned.

The value of the setting value D_{SET} when the OCP_DET signal becomes asserted is written as the critical value D_{SET_OCP} to the nonvolatile memory 210.

### Example 2

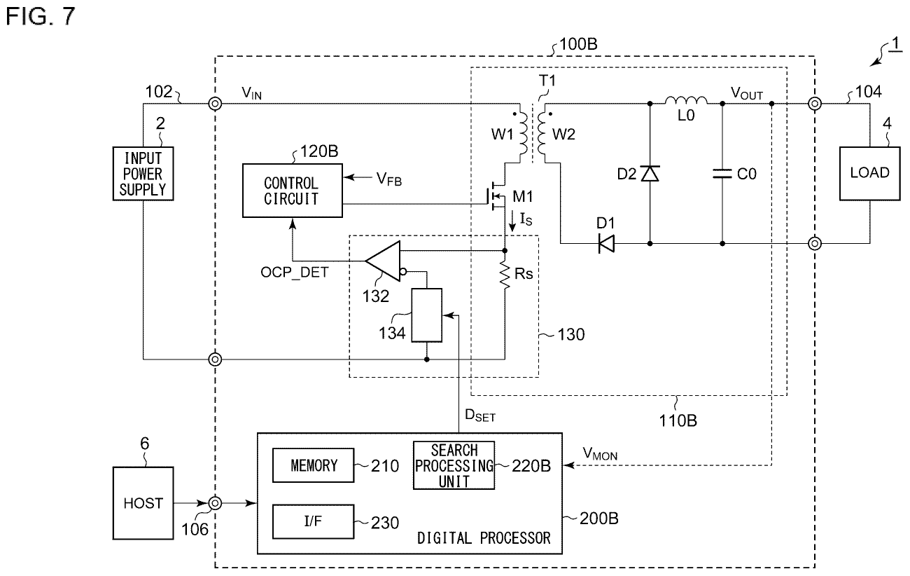

FIG. 7 is a circuit diagram of a switching power supply apparatus 100B according to Example 2. In the switching power supply apparatus 100B, the OCP_DET signal is input to the control circuit 120B. When the OCP_DET signal is asserted, the control circuit 120B limits or reduces the duty cycle of the switching element M1. For example, the control circuit 120B may be provided with a pulse-by-pulse overcurrent protection function of turning off the switching element M1 in response to the assertion of the OCP_DET signal.

A monitoring signal V_{MON} that corresponds to the output voltage V_{OUT} of the main circuit 110B is input to a digital processor 200B. In a case of employing a non-isolated application, the output voltage V_{OUT} may be transmitted to the primary side and may be employed as the monitoring signal V_{MON} as it is. In a case of employing an isolated application, the monitoring signal V_{MON} may preferably be generated using a photocoupler or an auxiliary winding. In a case of employing a photocoupler, a current on the output side of the light-receiving element may be converted into a voltage, and the converted voltage may be employed as the monitoring signal V_{MON}.

A search processing unit 220B of the digital processor 200B judges based on the monitoring signal V_{MON} whether or not the overcurrent protection has functioned. During a period in which the overcurrent protection is not functioning, the output voltage V_{OUT} is stabilized to its target level V_{OUT(REF)} by a feedback operation of the control circuit 120B. In this state, the monitoring signal V_{MON} is set to a first state.

When the overcurrent protection is functioning, the turn-on time of the switching element M1 is reduced, thereby reducing the output power of the main circuit 110B. As a result, the output voltage V_{OUT} cannot be maintained at the target level V_{OUT(REF)}. In this state, the monitoring signal V_{MON} is set to a second state.

Accordingly, when the monitoring signal V_{MON} is in the first state, the search processing unit 220B judges that the overcurrent protection is not functioning. Conversely, when the monitoring signal V_{MON} is in the second state, the search processing unit 220B judges that the overcurrent protection is functioning.

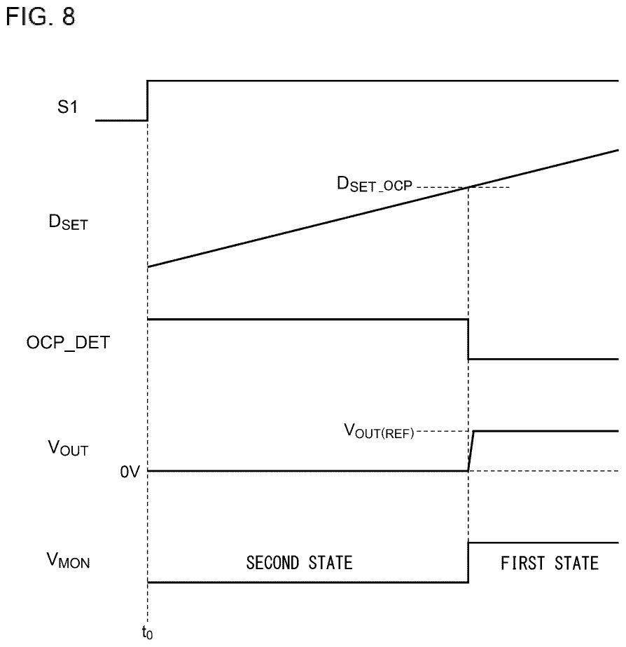

FIG. 8 is a waveform diagram showing a first example of operation in the calibration step of the switching power supply apparatus 100B shown in FIG. 7. When the adjustment start signal S1 is asserted at the time point to, the search processing unit 220B sweeps up the setting value D_{SET} from a low value to a high value.

In a range in which the setting value D_{SET} is low, the overcurrent protection operation threshold value is low. Accordingly, the OCP_DET is asserted. In this state, the duty cycle of the switching element M1 is limited by the control circuit 120B. As a result, the output voltage V_{OUT} is set to a lower level than the target level V_{OUT(REF)}. In this state, the monitoring signal V_{MON} is set to a second state (low level, in this example). The search processing unit 220B judges that the overcurrent protection is functioning, based on the monitoring signal V_{MON} set to the second state.

When the setting value D_{SET} exceeds a particular critical value D_{SET_OCP}, the OCP_DET signal is not asserted. In this state, the duty cycle of the switching element M1 is not limited by the control circuit 120B. As a result, the output voltage V_{OUT} is maintained at the target level V_{OUT(REF)}. As a result, the monitoring signal V_{MON} is set to the first state. Based on the monitoring signal V_{MON} set to the first state, the search processing unit 220B judges that the overcurrent protection is not functioning.

The digital processor 200B writes the setting value D_{SET} as the critical value D_{SET_OCP} to the nonvolatile memory 210 when the monitoring signal V_{MON} transits from the second state (low level) to the first state (high level).

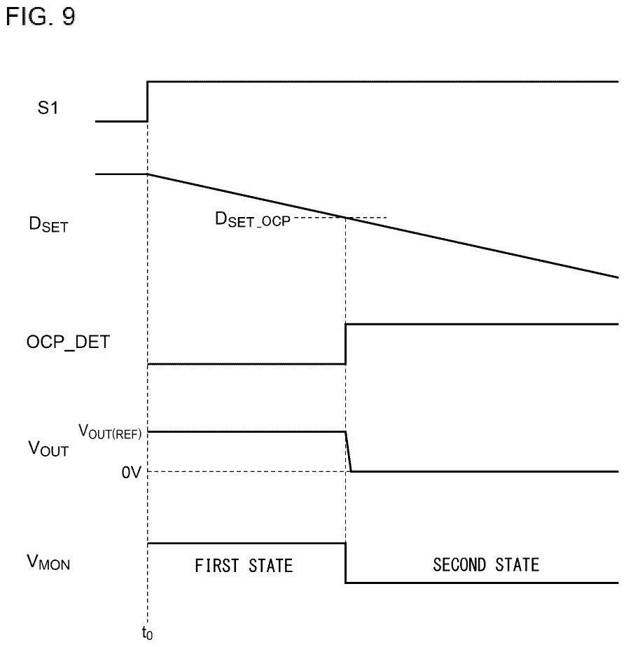

FIG. 9 is a waveform diagram showing a second example of operation of the switching power supply apparatus 100B shown in FIG. 7 in the calibration step. When the adjustment start signal S1 is asserted at the time point to, the search processing unit 220B sweeps down the setting value D_{SET} from a high value to a low value.

In a range in which the setting value D_{SET} is high, the operation threshold value of the overcurrent protection is high. Accordingly, the OCP_DET signal is not asserted. In this state, the duty cycle of the switching element M1 is not limited. As a result, the output voltage V_{OUT} is stabilized to the target level V_{OUT(REF)}. In this case, the monitoring signal V_{MON} is set to a first state (high level, in this example). The search processing unit 220B judges that the overcurrent protection is not functioning, based on the monitoring signal V_{MON} set to the first state.

When the setting value D_{SET} becomes lower than a particular critical value D_{SET_OCP}, the OCP_DET signal is asserted. In this state, the duty cycle of the switching element M1 is limited by the control circuit 120B. Accordingly, the output voltage V_{OUT} cannot be maintained at the target level V_{OUT(REF)}. As a result, the monitoring signal V_{MON} becomes the second state (low level, in this example). The search processing unit 220B judges that the overcurrent protection is functioning, based on the monitoring signal V_{MON} set to the second state.

The digital processor 200B writes the setting value D_{SET} as the critical value D_{SET_OCP} to the nonvolatile memory 210 when the monitoring signal V_{MON} transits from the first state (high level) to the second state (low level).

### Example 3

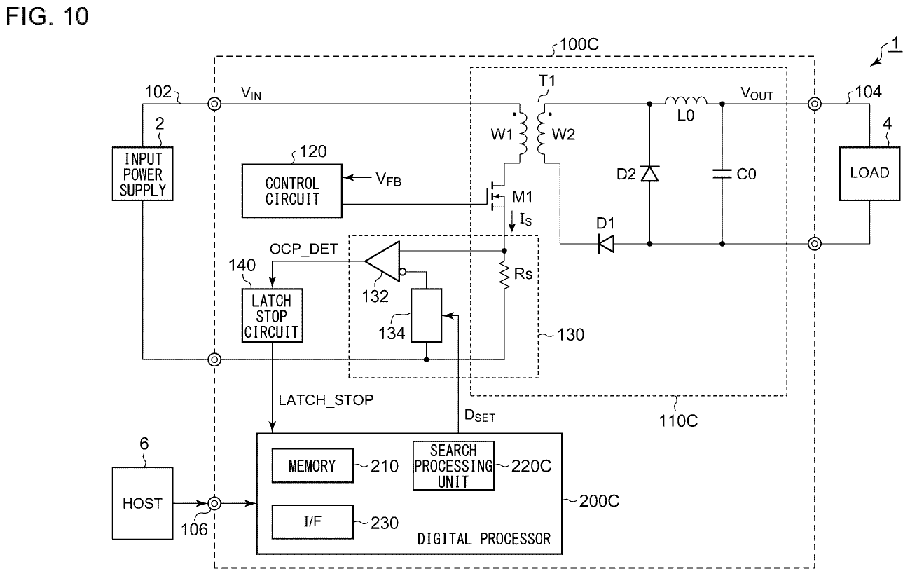

FIG. 10 is a circuit diagram of a switching power supply apparatus 100C according to Example 3. The switching power supply apparatus 100C is provided with a latch stop circuit 140 in addition to the switching power supply apparatus 100A shown in FIG. 4. The latch stop circuit 140 monitors the OCP_DET signal, and asserts a latch stop signal LATCH_STOP in response to the assertion of the OCP_DET signal. The control circuit 120 or the digital processor 200C stops the operation of the switching power supply apparatus 100C in response to the assertion of the latch stop signal LATCH_STOP.

In Example 3, the latch stop signal LATCH_STOP generated by the latch stop circuit 140 is input to the digital processor 200C. The search processing unit 220C of the digital processor 200C monitors the latch stop signal LATCH_STOP. In the search for the critical value, the search processing unit 220C judges based on the LATCH_STOP signal whether or not the overcurrent protection is functioning. Specifically, upon detecting the assertion of the LATCH_STOP signal, the search processing unit 220C judges that the overcurrent protection is functioning. Conversely, when the LATCH_STOP signal is negated, the search processing unit 220C judges that the overcurrent protection is not functioning.

The above is the configuration of the switching power supply apparatus 100C.

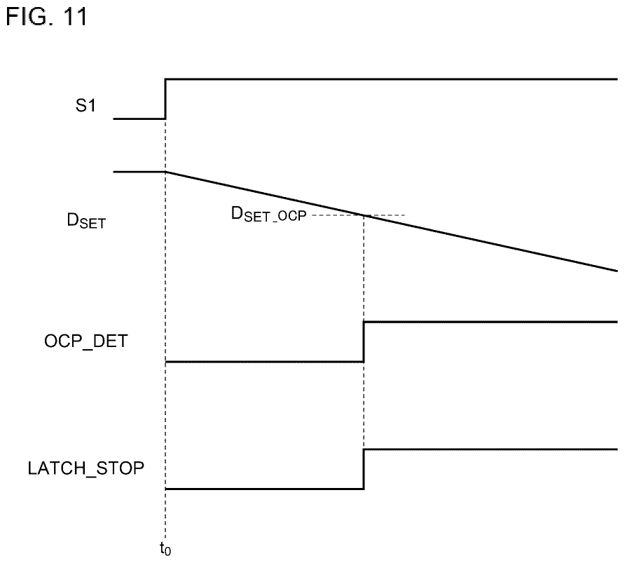

FIG. 11 is a waveform diagram showing an example of operation of the switching power supply apparatus 100C shown in FIG. 10 in the calibration step. When the adjustment start signal S1 is asserted at the time point to, the search processing unit 220C sweeps down the setting value D_{SET} from a high value to a low value.

In a range in which the setting value D_{SET} is high, the OCP_DET signal is not asserted. Accordingly, the LATCH_STOP signal is negated. The search processing unit 220C judges that the overcurrent protection is not functioning based on the LATCH_STOP signal set to the negated state.

When the setting value D_{SET} becomes lower than a given particular value D_{SET_OCP}, the OCP_DET signal is asserted, and accordingly, the LATCH_STOP signal is asserted. The search processing unit 220C judges that the current protection is functioning based on the assertion of the LATCH_STOP signal.

The digital processor 200C writes the setting value D_{SET} as the critical value D_{SET_OCP} to the nonvolatile memory 210 when the LATCH_STOP signal is asserted.

The above is the operation of the switching power supply apparatus 100C. It should be noted that, with the switching power supply apparatus 100C, the setting value D_{SET} may be swept up. In this case, the switching power supply apparatus 100C is latch stopped every time the setting value D_{SET} is changed until the critical value is found. With such an arrangement in which the switching power supply apparatus 100C is latch stopped, it is necessary to release the latch stop so as to restart the switching power supply apparatus 100C. This leads to an increased calibration time. With Example 3 in which setting value D_{SET} is swept down as shown in FIG. 11, a latch stop does not occur until the critical value D_{SET_OCP} is found, thereby providing a short search time.

The above-described embodiment has been described for exemplary purposes only. Rather, it can be readily conceived by those skilled in this art that various modifications may be made with respect to various combinations of the aforementioned components or processes. Description will be made below regarding such modifications.

### Modification 1

Description has been made in Examples 1 through 3 regarding an arrangement in which the setting value D_{SET} is swept. However, the present invention is not restricted to such an arrangement. Also, a binary search may be employed.

### Modification 2

Description has been made in the embodiments regarding an arrangement in which the adjustment start signal S1 is input as communication data to the communication interface 230. However, the present invention is not restricted to such an arrangement. Also, the adjustment start signal S1 may be input via a dedicated control line. Also, before the input of the adjustment start signal S1, an adjustment preparation signal may be supplied to the digital processor 200. Also, the digital processor 200 may prepare calibration in response to the adjustment preparation signal. Also, the digital processor 200 may start the sweeping of the setting value D_{SET} with the adjustment start signal S1 as a trigger.

### Modification 3

Description has been made in Examples 1 through 3 regarding an arrangement in which overcurrent is detected based on the current I_{S} that flows through the primary winding W1 of the transformer T1. However, the present invention is not restricted to such an arrangement. Also, an overcurrent detection circuit may be arranged on the secondary winding W2 side of the transformer T1. Also, the overcurrent protection circuit may be configured with the current on the secondary side as the current I_{S} to be detected.

The embodiments show only an aspect of the mechanisms and applications of the present invention. Rather, various modifications and various changes in the layout can be made without departing from the spirit and scope of the present invention defined in appended claims.

### Notes

The following techniques are disclosed in the present specification.

### Item 1

A switching power supply apparatus comprising:
at least one switching element,
a control circuit structured to drive the at least one switching element,
an overcurrent detection circuit structured to assert an overcurrent detection signal when a current that flows through a predetermined path of the switching power supply apparatus exceeds a threshold current, and to be capable of adjusting the threshold current according to a setting value,
nonvolatile memory structured to hold a setting value to be supplied to the overcurrent detection circuit in normal operation of the switching power supply apparatus,
a search processing unit structured to change the setting value in the calibration step so as to search for a critical value to be employed as the setting value that corresponds to a boundary that defines whether or not the overcurrent protection functions when the switching power supply apparatus operates with a current value at which the overcurrent protection is to function in normal operation thereof; and
a digital processor structured to write the critical value obtained by the search by the search processing unit to the nonvolatile memory in the calibration step, and to read the critical value from the nonvolatile memory so as to supply the critical value as the setting value in the overcurrent detection circuit in a normal startup operation of the switching power supply apparatus.

### Item 2

The switching power supply apparatus according to item 1, wherein, in the calibration step, a constant current load structured to generate a predetermined constant current is coupled to an output terminal of the switching power supply apparatus.

### Item 3

The switching power supply apparatus according to item 1 or 2, wherein the switching power supply apparatus is structured as a switching converter comprising a transformer,
and wherein the switching element is coupled to a primary winding of the transformer.

### Item 4

The switching power supply apparatus according to item 3, wherein the predetermined path is structured as a path arranged in series with a primary winding of the transformer.

### Item 5

The switching power supply apparatus according to any one of items 1 through 4, wherein the search processing unit monitors whether or not the overcurrent detection signal is asserted or negated while changing the setting value.

### Item 6

The switching power supply apparatus according to any one of items 1 through 4, wherein the search processing unit monitors a voltage level of an output voltage of the switching power supply apparatus while changing the setting value.

### Item 7

The switching power supply apparatus according to any one of items 1 through 6, wherein the search processing unit continuously sweeps the setting value.

### Item 8

The switching power supply apparatus according to any one of items 1 through 7, wherein the search processing unit continuously sweeps the setting value from a larger value toward a smaller value.

### Item 9

The switching power supply apparatus according to any one of items 1 through 7, wherein the search processing unit continuously sweeps the setting value from a smaller value toward a larger value.

### Item 10

The switching power supply apparatus according to item 8, structured to latch stop in response to an assertion of the overcurrent detection signal.

### Item 11

The switching power supply apparatus according to any one of items 1 through 4, further comprising a latch stop circuit structured to generate a latch stop signal in response to an assertion of the overcurrent detection signal,
wherein the search processing unit monitors the latch stop signal.

### Item 12

The switching power supply apparatus according to any one of items 1 through 10, wherein a function of the search processing unit is provided as a software process implemented in the same hardware component as the digital processor.

### Item 13

The switching power supply apparatus according to any one of items 1 through 10, wherein a function of the overcurrent detection circuit is provided as a hardware operation external to the digital processor.

### Item 14

The switching power supply apparatus according to any one of items 1 through 10, wherein a function of the search processing unit is provided as a hardware operation or a software process implemented in the same hardware component as the digital processor.

### Item 15

A digital processor to be employed in a switching power supply apparatus, wherein the switching power supply apparatus comprises:
at least one switching element,
a control circuit structured to drive the at least one switching element; and
an overcurrent detection circuit structured to assert an overcurrent detection signal when a current that flows through a predetermined path of the switching power supply apparatus exceeds a threshold current, and to be capable of adjusting the threshold current according to a setting value,
and wherein the digital processor comprises:
   nonvolatile memory structured to hold the setting value; and
   a processing unit structured to receive an adjustment start signal, to enter a calibration mode with the adjustment start signal as a trigger, to change the setting value in a state in which the switching power supply apparatus is operated with a current at which overcurrent protection is to function in normal operation of the switching power supply apparatus, so as to search for a critical value that corresponds to a boundary that defines whether or not the overcurrent protection functions, to write the critical value obtained as a result of the search to be used as the setting value to the nonvolatile memory, and to read the critical value from the nonvolatile memory so as to set the critical value in the overcurrent detection circuit in a normal startup operation of the switching power supply apparatus.

### Item 16

A calibration method for a switching power supply apparatus, wherein the switching power supply apparatus comprises:
at least one switching element; and
an overcurrent detection circuit structured to assert an overcurrent detection signal when a current that flows through a predetermined path of the switching power supply apparatus exceeds a threshold current, and to be capable of adjusting the threshold current according to a setting value,
and wherein the calibration method comprises:
   operating the switching power supply apparatus in a critical state in which overcurrent protection is to function in normal operation,
   searching for a critical value that corresponds to a boundary that defines whether or not the overcurrent protection functions while changing the setting value; and
   storing a value based on the critical value obtained by the search in the nonvolatile memory as the setting value to be set in the overcurrent detection circuit in normal operation of the switching power supply apparatus.

What is claimed is:

1. A switching power supply apparatus comprising:
at least one switching element;
a control circuit structured to drive the at least one switching element,
an overcurrent detection circuit structured to assert an overcurrent detection signal when a current that flows through a predetermined path of the switching power supply apparatus exceeds a threshold current, and to be capable of adjusting the threshold current according to a setting value,
nonvolatile memory structured to hold a setting value to be supplied to the overcurrent detection circuit in normal operation of the switching power supply apparatus,
a search processing unit structured to change the setting value in the calibration step so as to search for a critical value to be employed as the setting value that corresponds to a boundary that defines whether or not the overcurrent protection functions when the switching power supply apparatus operates with a current value at which the overcurrent protection is to function in normal operation thereof; and
a digital processor structured to write the critical value obtained by the search by the search processing unit to the nonvolatile memory in the calibration step, and to read the critical value from the nonvolatile memory so as to supply the critical value as the setting value in the overcurrent detection circuit in a normal startup operation of the switching power supply apparatus.

2. The switching power supply apparatus according to claim 1, wherein, in the calibration step, a constant current load structured to generate a predetermined constant current is coupled to an output terminal of the switching power supply apparatus.

3. The switching power supply apparatus according to claim 1, wherein the switching power supply apparatus is structured as a switching converter comprising a transformer,
and wherein the switching element is coupled to a primary winding of the transformer.

4. The switching power supply apparatus according to claim 3, wherein the predetermined path is structured as a path arranged in series with a primary winding of the transformer.

5. The switching power supply apparatus according to claim 1, wherein the search processing unit monitors whether or not the overcurrent detection signal is asserted or negated while changing the setting value.

6. The switching power supply apparatus according to claim 1, wherein the search processing unit monitors a voltage level of an output voltage of the switching power supply apparatus while changing the setting value.

7. The switching power supply apparatus according to claim 1, wherein the search processing unit continuously sweeps the setting value.

8. The switching power supply apparatus according to claim 1, wherein the search processing unit continuously sweeps the setting value from a larger value toward a smaller value.

9. The switching power supply apparatus according to claim 1, wherein the search processing unit continuously sweeps the setting value from a smaller value toward a larger value.

10. The switching power supply apparatus according to claim 8, structured to latch stop in response to an assertion of the overcurrent detection signal.

11. The switching power supply apparatus according to claim 1, further comprising a latch stop circuit structured to generate a latch stop signal in response to an assertion of the overcurrent detection signal,
wherein the search processing unit monitors the latch stop signal.

12. The switching power supply apparatus according to claim 1, wherein a function of the search processing unit is provided as a software process implemented in the same hardware component as the digital processor.

13. The switching power supply apparatus according to claim 1, wherein a function of the overcurrent detection circuit is provided as a hardware operation external to the digital processor.

14. The switching power supply apparatus according to claim 1, wherein a function of the search processing unit is provided as a hardware operation or a software process implemented in the same hardware component as the digital processor.

15. A digital processor to be employed in a switching power supply apparatus, wherein the switching power supply apparatus comprises:
at least one switching element,
a control circuit structured to drive the at least one switching element; and
an overcurrent detection circuit structured to assert an overcurrent detection signal when a current that flows through a predetermined path of the switching power supply apparatus exceeds a threshold current, and to be capable of adjusting the threshold current according to a setting value,
and wherein the digital processor comprises:
nonvolatile memory structured to hold the setting value; and
a processing unit structured to receive an adjustment start signal, to enter a calibration mode with the adjustment start signal as a trigger, to change the setting value in a state in which the switching power supply apparatus is operated with a current at which overcurrent protection is to function in normal operation of the switching power supply apparatus, so as to search for a critical value that corresponds to a boundary that defines whether or not the overcurrent protection functions, to write the critical value obtained as a result of the search to be used as the setting value to the nonvolatile memory, and to read the critical value from the nonvolatile memory so as to set the critical value in the overcurrent detection circuit in a normal startup operation of the switching power supply apparatus.

16. A calibration method for a switching power supply apparatus, wherein the switching power supply apparatus comprises:
at least one switching element; and
an overcurrent detection circuit structured to assert an overcurrent detection signal when a current that flows through a predetermined path of the switching power supply apparatus exceeds a threshold current, and to be capable of adjusting the threshold current according to a setting value,
and wherein the calibration method comprises:
operating the switching power supply apparatus in a critical state in which overcurrent protection is to function in normal operation,
searching for a critical value that corresponds to a boundary that defines whether or not the overcurrent protection functions while changing the setting value; and
storing a value based on the critical value obtained by the search in the nonvolatile memory as the setting value to be set in the overcurrent detection circuit in normal operation of the switching power supply apparatus.
